(19) United States
(12) Patent Application Publication
(10) Pub. No.: US 2025/0265130 A1
(43) Pub. Date: Aug. 21, 2025

(54) DATA MOVEMENT CRITERIA FOR AN INFORMATION HANDLING SYSTEM

(71) Applicant: DELL PRODUCTS L.P., Round Rock, TX (US)

(72) Inventors: Farzad Khosrowpour, Pflugerville, TX (US); Mitchell Markow, Hutto, TX (US); Ajay Kwatra, Austin, TX (US)

(21) Appl. No.: 18/444,932

(22) Filed: Feb. 19, 2024

(51) Int. Cl. G06F 9/50

(52) U.S. Cl. CPC G06F 9/5088; G06F 9/5044; G06F 9/5094; G06F 2209/5022; G06F 2209/504; G06F 2209/509

(57) ABSTRACT

An information handling system includes a memory and a processor. The memory stores a quality of service (QOS) table that includes parameters for a target application. The processor identifies the target application from multiple applications and receives a requested QoS for the target application. The processor determines a system workload class associated with the target application and determines a system level QoS associated with the target application. Based on the requested QoS, the system workload class, and the system level QoS, the processor determines a derived QoS for the target application. The requested QoS, the system workload class, the system level QoS, and the derived QoS are stored in the QoS table. Based on the derived QoS, the processor determines whether the target application is a candidate for migration from the information handling system to an offload compute device.

### FIELD OF THE DISCLOSURE

The present disclosure generally relates to information handling systems, and more particularly relates to data movement criteria for an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may store a quality of service (QOS) table that includes parameters for a target application. The system may identify the target application from multiple applications and receive a requested QoS for the target application. The information handling system may determine a system workload class associated with the target application and determine a system level QoS associated with the target application. Based on the requested QoS, the system workload class, and the system level QoS, the information handling system may determine a derived QoS for the target application. The requested QoS, the system workload class, the system level QoS, and the derived QoS are stored in the QoS table. Based on the derived QoS, the information handling system may determine whether the target application is a candidate for migration from the information handling system to an offload compute device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of a system including an information handling system and an offload compute device according to at least one embodiment of the present disclosure;

FIG. 2 is a graphical representation of tradeoffs between power, performance, and latency parameters for an application executed in an information handling system according to at least one embodiment of the present disclosure;

FIG. 3 is a graphical representation of different quality of service quadrants for applications executed in an information handling system according to at least one embodiment of the present disclosure;

FIG. 4 is a flow diagram of a method for migrating data between an information handling system and an offload compute device according to at least one embodiment of the present disclosure; and

FIG. 5 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

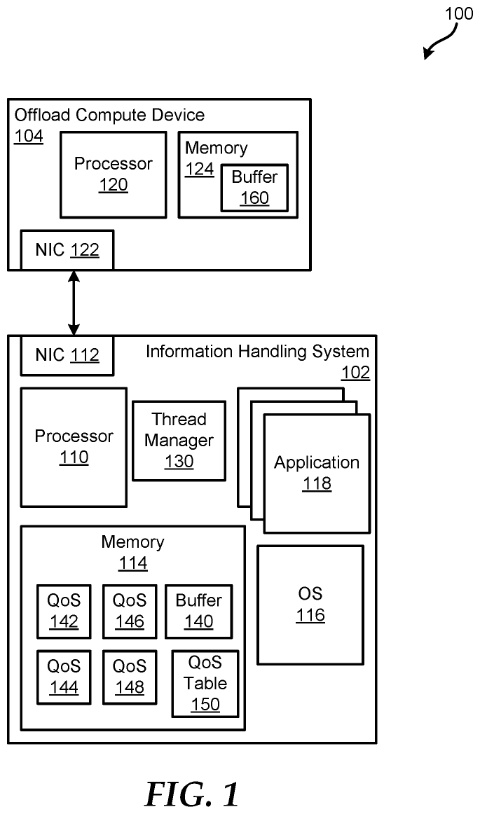

FIG. 1 illustrates a system 100 including an information handling system 102 and an offload compute device 104 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes a processor 110, a network interface card (NIC) 112, a memory 114, an operating system (OS) 116, and multiple applications 118. Offload compute device 104 includes a processor 120, a NIC 122, and a memory 124. Offload compute device 104 may be any suitable device external to information handling system 102, such as an edge compute device, a dedicated compute server, a remote cloud server, or the like. Processor 110 may execute a thread manager 130. Memory 114 may store different data and information associated with information handling system 102. For example, memory 114 may store a buffer 140, multiple quality of service (QOS) 142, 144, 146, and 148 (142-148), and a QoS table 150. Memory 124 stores a buffer 160 to be utilized store data for use by processor 120. Processor 110 may be a multi-core processor such that the different cores may execute different threads of OS 116. These different threads may include, but are not limited to, different applications 118 and thread manager 130. Information handling system 102 and offload compute device 104 may include additional components without varying from the scope of this disclosure.

In certain examples, processor 110 may execute one or more of applications 118, such as an inference model or the like. In an example, a target application 118 may need to meet a particular QoS, such as one of QoS 142-148 to provide a good user experience of the operation of information handling system 100. In certain examples, if system resources are not effectively provided to meet QoS 142 of application 118, sluggishness or excessive power usage may occur by processor 110 in information handling system 102. In an attempt to prevent these conditions in information handling system 102, workloads of applications 118 may be migrated between the information handling system and offload compute device 104 to better enable other concurrent applications executed in processor 110 to utilize the system resources.

In current information handling systems, the QoS of an application may only be defined for native processing. However, the criteria for determining whether to move the workloads may depend on many system and application parameters. Information handling system 102 may be improved by thread manager 130 in processor 110 defining and utilizing optimal criteria for workload movement between information handling system 102 and offload compute device 104 while balancing a tradeoff between system parameters.

In an example, information handling system 102 may be improved by processor 110 measuring a QoS for the information handling system, measuring, and using the QoS of target application 118, matching these conditions and driving the decision for workload movement. Information handling system 102 may be further improved by processor 110 making critical decisions that allows efficient workload migration for best power and performance while meeting the application latency requirements. In an example, processor 110 may utilize a QoS defined by an application performance, minimum required latency, and overall power consumption in information handling system 102. In certain examples, heavier workloads may be better candidates for migration to offload compute device 104. However, the heavy workloads may also include network dependencies whose latency criteria cannot be met by the migration to offload compute device 104. Therefore, information handling system 102 may be improved by mapping tradeoffs between the application performance, minimum required latency, and overall power consumption in information handling system 102 to a proper QoS.

During operation, processor 110 may identify application 118 as a target application to be executed. After target application 118 is identified, processor 110 may classify the target application. In certain examples, the classification of target application 118 may be determined based on any suitable criteria, such as an algorithm complexity of the application, an algorithm responsiveness of the application, QoS 142 for the application, or the like. Target application 118 may be any suitable application such as an inference model. In an example, QoS 142 for identified application 118 may include, but is not limited to, an energy performance preference, a maximum performance level, a scheduling policy, and that a scheduling policy is not present for the application. In certain examples, the performance levels of target application 118 in QoS 142 may be key performance indicators (KPIs) for the application and information handling system 102.

In an example, application 118 may request a QoS from OS 116, and this request may be based on internal design needs of the application. In certain examples, the internal design needs may be based on an algorithm complexity and responsiveness needed for application 118. In an example, processor 118 may determine an algorithm complexity based on any suitable factors, such as through space complexity analysis, code paths, and profiling, trusting app developers. In certain examples, the responsive of application 118 may be characterized based on user response, real time response, or the like. The real time response may be inter-process communication requirements. In an example, QoS 142 for application 118, an algorithm complexity of the application, and the responsiveness of the application are illustrated in Table 1:

TABLE 1

| | | Responsiveness to |
|---|---|---|
| | CPU usage via | user <1 Sec and |
| Application QoS | Algorithm Complexity | real-time <250 mSec |
| NoPolicy | Low-Medium | Not Critical |
| Schedule Policy | Medium | Adjustable |
| Energy Performance | Medium-High | Meet Specification |
| Maximum Performance | High | All Critical |

As shown in Table 2, QoS 104 of application 118 may include, but is not limited to, an energy performance preference policy, a maximum performance policy, a scheduling policy, and no policy. Additionally, the algorithm complexity may affect the usage of processor 110 and this usage may be defined by different levels, such as low, low-medium, medium, medium-high, and high. As illustrated in Table 2, the responsiveness of application 118 may also be defined as not critical, adjustable, meet specification, all critical or the like.

In certain examples, when application 118 requests system resources from thread manager 130, the request may include a type of QoS needed by the application. Based on the request, thread manager 130 may schedule the requesting application threads and other application threads efficiently. In an example, memory 114 include a map of efficiency and performance cores in processor 110. OS 116 via thread manager 130 may utilize the map to assign QoS 142 of application 118 to the proper core of processor 110. In certain examples, application 118 is not able to determine availability of system resources such as horsepower of processor 110. Application 118 may also not have access to the capabilities of NIC 112 and capabilities of the connection between the NIC of information handling system 102 and NIC 122.

Based on application 118 not having access to or knowledge about system resources, network capabilities, or the like, the requested QoS 142 of the application may lead to incorrect behavior by the application. For example, application 118 may be characterized as ‘misbehaving’ based on the application requesting or demanding system resources that are not necessary for the execution of the application. In an example, if application 118 is misbehaving, the resource request from the application may put an unnecessary burden on systems resources of information handling system 102. Based on the possibility of requested QoS 142 putting an unnecessary burden on systems resources, processor 110 may utilize the requested QoS only as a portion or hint to the selection of the overall QoS for application 118. In an example, processor 110 may determine whether the behavior or operations of application 118 match requested QoS 142 received from the application.

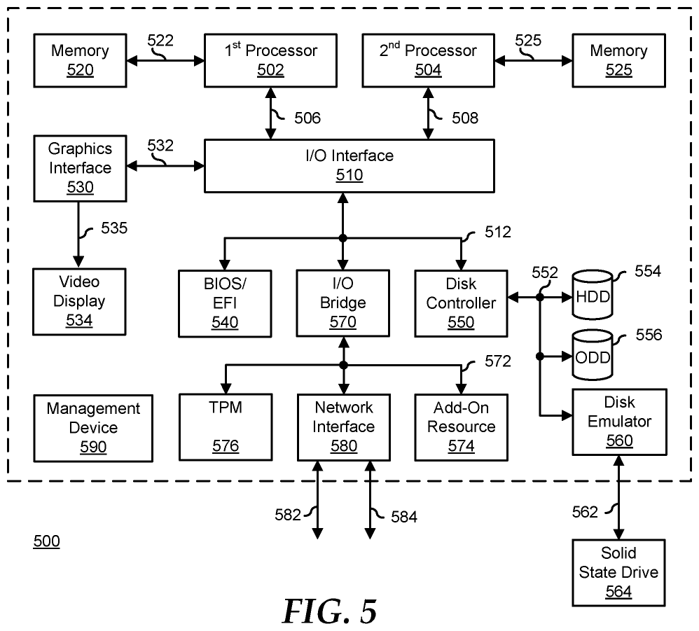

In certain examples, processor 110 may determine that the behavior of application 118 does not match requested QoS 142 when the application is demanding resources that are not necessary and putting unnecessary burden on resources of information handling system 102. If the behavior of application 118 does not match requested QoS 142, processor 110 may provide a request to override the policy or ignore the behavior of the application a user of information handling system 102. In an example, processor 110 may provide the request via any suitable manner, such as a message provided by a graphical user interface output on a display device, such as video display 500 of information handling system 500 in FIG. 5.

Based on the response to the request, processor 110 may change a policy in QoS 142 of application 118 or ignore the behavior of the application. In an example, the update of the policy may include, but is not limited to, processor 118 changing QoS 142 for application 118 to include the requested resources, increasing an energy performance preference, and increasing a maximum performance level. In certain examples, these changes to QoS 142 may be changes to KPIs of the information handling system 102.

In an example, if the behavior of application 118 matches requested QoS 142, processor 110 may determine a system workload class. In certain examples, the system workload class may be any suitable identifier for resources utilized/current workloads of information handling system 102, such as whether the currently executed workloads are network usage heavy workloads, high computation workloads, light workloads, or the like. In certain examples, the high computation workloads may be workloads executed in by processor 110 within information handling system 102, workloads migrated over the network to offload compute device 104, or the like.

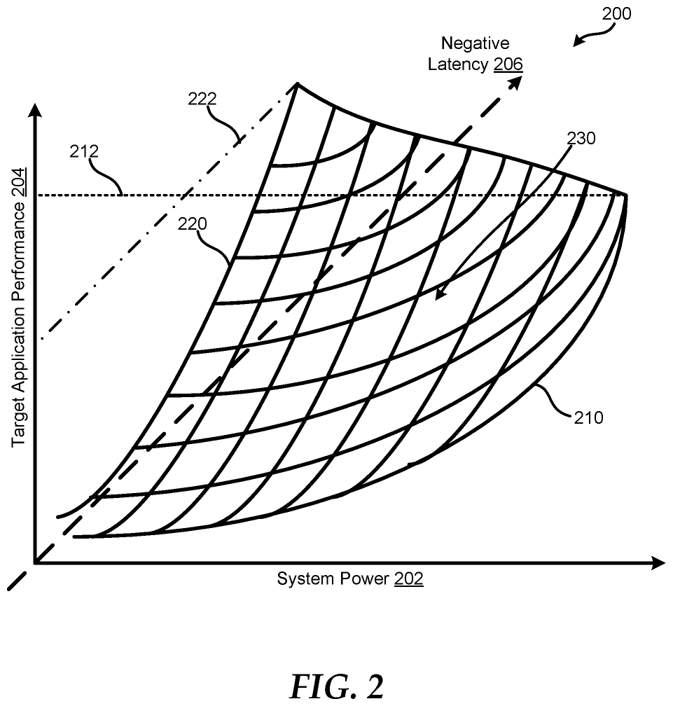

In response to the system workload class being determined, processor 110 may determine a system level QoS 144. In an example, system level QoS 144 may include, but is not limited to, a maximum system power consumption, a maximum computation workload, a thread/application latency, and a schedule policy. In certain examples, system level QoS 144 may be determined based on tradeoffs between a system power consumption, an application performance, and an application latency as will be described with respect to FIG. 2.

FIG. 2 shows tradeoffs 200 between system power 202, application performance 204, and application latency 206 for an application executed in an information handling system according to at least one embodiment of the present disclosure. In FIG. 2 application latency 206 is illustrated negatively, such that the latency value decreases as the latency moves away from the origin. Additionally, the negative graphing of application latency 206 may simplify plotting of the application latency. Graphical representation 200 illustrates the tradeoff between system power 202, application performance 204, and application latency 206 in a three-dimensional (3-D) space.

In an example, line 210 represents the relationship between the change of application performance 204 and the change of the consumption of system power 202. For example, as application performance 204 increases, the consumption of system power 202 also increases. In certain examples, application performance 204 may increase up to a physical maximum, represented by dashed line 212.

In an example, line 220 represents the relationship between a negative change of application latency 206 and a positive change in application performance 204. For example, as application latency 206 decreases, application performance 204 increases. In an example, application latency 206 may decrease to a level that increases until a maximum application performance 204, represented by dashed line 222.

In certain examples, system power 202, application performance 204, and application latency 206 may be key performance indicators (KPIs) for applications executed in an information handling system, such as information handling system 100 of FIG. 1. In an example, a 3D net contour 230 may be created based on tradeoffs between system power 202, application performance 204, and application latency 206. In an example, contour 320 may represent an analysis of this tradeoff between the KPIs.

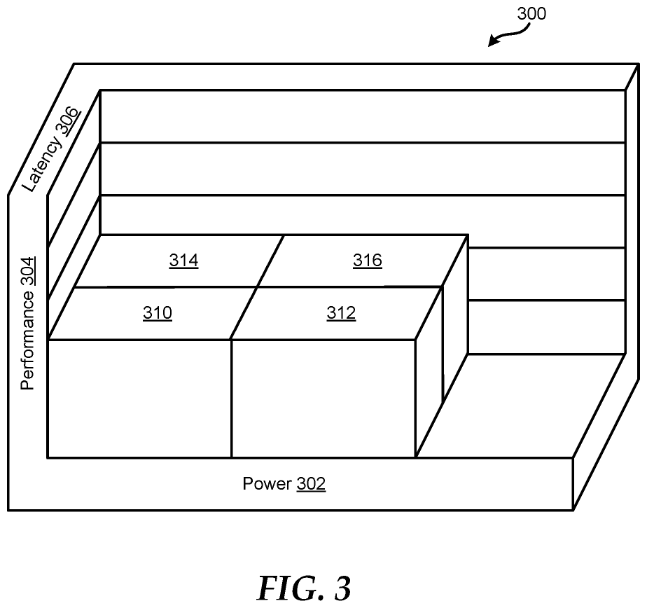

Referring back to FIG. 1, processor 110 may perform any suitable operations to determine whether target application 118 is a candidate to migrate to offload compute device 104. For example, processor 110 may assign target application 118 to a particular latency/power quadrant as will be described with respect to FIG. 3.

FIG. 3 illustrates a graphical representation 300 for different system QoS levels, such as system power 302, application performance 304, and application latency 306 according to at least one embodiment of the present disclosure. In an example, the different system QoS levels 302, 304, and 306 may be for all of the applications executed in an information handling system, such as information handling system 100 of FIG. 1. Power, performance, and latency requirements 302, 304, and 306 may be divided or grouped into different QoS quadrants 310, 312, 314, and 316 for applications executed in an information handling system. While QoS quadrants 310, 312, 314, and 316 are illustrated as occupying a small portion of possible value ranges of power 302, performance 304, and latency 306, the QoS quadrants may occupy any suitable amount of possible value ranges without varying from the scope of this disclosure. For example, QoS quadrants 310, 312, 314, and 316 may occupy a smaller amount of possible value ranges and up to the entire possible value ranges of power 302, performance 304, and latency 306.

In an example, QoS quadrants may be defined based on different latency and power ranges. The latency ranges may be a low to medium (L-M) latency requirement, a medium to high (M-H) latency requirement, or the like. Similarly, the power ranges may be a low to medium (L-M) power requirement, a medium to high (M-H) power requirement, or the like. In certain examples, QoS quadrant 310 may set the latency and power requirements as L-M latency and L-M power. QoS quadrant 312 may set the latency and power requirements as L-M latency and M-H power. QoS quadrant 314 may set the latency and power requirements as M-H latency and L-M power. QoS quadrant 316 may set the latency and power requirements as M-H latency and M-H power. One of ordinary skill would recognize that these are exemplary QoS requirement ranges, and any other ranges may be utilized without varying from the scope of this disclosure.

Referring back to FIG. 1, the assigned QoS quadrant may be populated in QoS table 150, stored in memory 114. In an example, QoS table 150 may be utilized to store different parameters associated with whether application 118 is a candidate for migration to offload compute device 104. For example, processor 110 may store multiple parameters associated with different applications 118 in QoS table 150 as shown in Table 2 below.

TABLE 2

| | | System | | | Candidate | |
|---|---|---|---|---|---|---|
| System | | Workload | Requested | Derived | for | Move |
| Level QoS | Quadrant | Class | QoS | QoS | Migration | based on |
| LM | MH Latency | Network Heavy | Schedule | L | No | |
| | LM Power | Workloads | Policy | | | |
| MH | MH Latency | High computation | Energy | M | Yes | If latency |
| | MH Power | workloads over | Performance | | | and response |
| | | network or high | | | | can be met |
| | | computation and | | | | |
| | | network heavy | | | | |
| | | workloads | | | | |
| L | LM Latency | Light Workloads | No Policy | L | No | |
| | LM Power | | | | | |
| H | LM Latency | High | Maximum | H | Yes | If response |
| | MH Power | computation | Performance | | | time can |
| | | workloads | | | | be met |

Table 2 may illustrate an exemplary QoS table 150 in FIG. 1. QOS table 150 may include any suitable number of entries for any suitable number of target applications 118 without varying from the scope of this disclosure. In an example, processor 110 may store a system level QoS for target application 118, such as LM, in the first row of Table 2. Additionally, processor 110 may assign target application 118 to quadrant 314 of FIG. 3, which may be a MH latency and LM power requirement for the target application as shown in the first row of Table 2. In an example, the system workload class for target application 118 may be identified as a network heavy workload and the requested QoS from the target application may be a schedule policy QoS as shown in the first row of Table 2. Based on these parameters for target application 118, processor 110 may assign this particular target application a low derived QoS, which in turn may identify that the target application is not a candidate for migration. In response to target application 118 not being a candidate for migration, thread manager 130 may assign the threads of the target application to a core of processor 110. Thus, processor 110, via thread manager 130 of OS 116, may utilize different parameters for target application 118 to determine whether the target application should be executed locally in information handling system 102 or migrated to offload compute device 104.

As illustrated in Table 2, different target applications 118 may have different results or determinations as to whether the target application is a candidate for migration to offload compute device 104. In an example, target application 118 associated with the second row of Table 2 may be a candidate for migration to offload compute device 104. For example, as shown in the second row of Table 2 the system level QoS for this target application 118 is MH, the target application is assigned to quadrant 306 of FIG. 3, such as MH latency and MH power, the system workload class for target application 118 may be identified as High computation workloads over network or high computation and network heavy workloads, and the requested QoS from the target application may be energy performance. Based on these parameters for target application 118 of the second row of parameters, processor 110 may assign this particular target application a medium derived QoS, which in turn may identify that the target application is a candidate for migration. Thus, the parameters for this target application 118 may be utilized to determine that the application should be migrated to offload compute device 104 for optimal operation.

In response to target application 118 being a candidate for migration, processor 110 may determine a combined server response QoS available for computation of the application. Processor 110 may then determine whether the requested QoS for the identified application 118 may be met by processor 120 of offload compute device 104. In an example, the QoS for identified application 118 may be met if the latency requirement for the application may be met, if offload compute device 104 has available resources to perform the computation workload for the application, or the like. If the requested QoS from application 118 may be met by offload compute device 104, the workload for identified target application 118 may be moved or migrated to the offload compute device via NICs 112 and 122. After the workload for target application 118 is completed, processor 120 of offload compute device 104 may provide the resulting data to processor 110 of information handling system 102 via NICs 112 and 122.

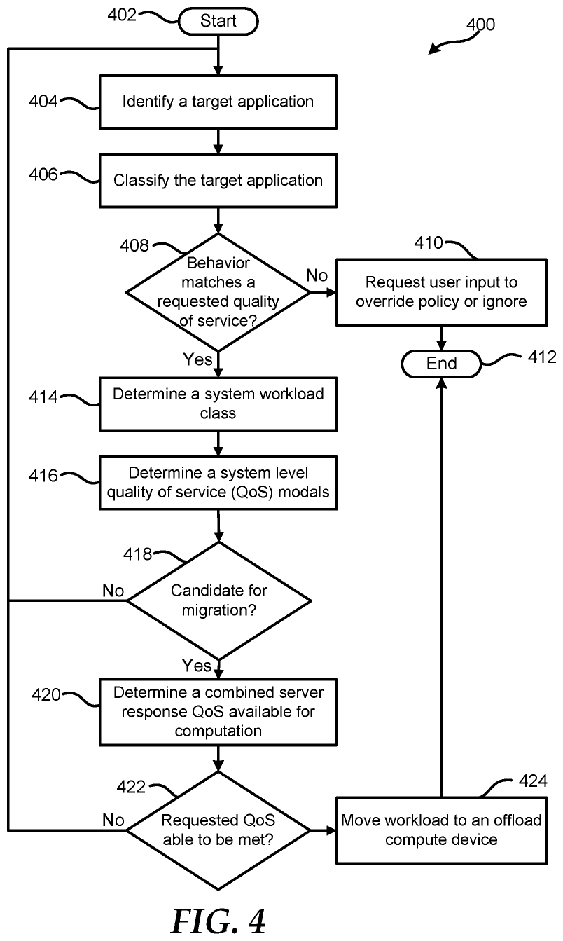

FIG. 4 is a flow diagram of a method 400 for migrating data between an information handling system and an offload compute device according to at least one embodiment of the present disclosure, starting at block 402. It will be readily appreciated that not every method step set forth in this flow diagram is always necessary, and that certain steps of the methods may be combined, performed simultaneously, in a different order, or perhaps omitted, without varying from the scope of the disclosure. FIG. 4 may be employed in whole, or in part, processor 110 and thread manager 130 of FIG. 1, or any other type of controller, device, module, processor, or any combination thereof, operable to employ all, or portions of, the method of FIG. 4.

At block 404, a target application is identified. In an example, the target application may be any suitable application executed by a processor of the information handling system. At block 406, the target application is classified. In certain examples, the classification of the application may be determined based on any suitable criteria, such as an algorithm complexity of the application, an algorithm responsiveness of the application, a quality of service (QOS) for the application, or the like. In an example, the QoS for the identified application may include, but is not limited to, an energy performance preference, a maximum performance level, a scheduling policy, and that a scheduling policy is not present for the application.

At block 408, a determination is made whether the behavior of application, such as the operations performed by the application, matches a requested QoS of the application. In certain examples, the behavior of the application does not match the QoS is the application is demanding resources that are not necessary and putting unnecessary burden on resources of the information handling system. If the behavior of the application does not match the requested QoS, a request to override the policy or ignore the behavior of the application is provided to a user of the information handling system at block 410 and the flow ends at block 412.

In an example, the request may be provided by any suitable manner, such as a message provided by a graphical user interface output on a display device of the information handling system. So, applications request of QoS can only be a hint to the overall QoS decision making. Based on the response to the request, the processor may change a policy in the QoS of the application or ignore the behavior of the application. In an example, the update of the policy may include, but is not limited to, changing the QoS for the application to include the requested resources, increasing an energy performance preference, and increasing a maximum performance level.

If the behavior of the application matches the requested QoS, a system workload class is determined at block 414. In an example, the system workload class may be any suitable identifier for resources utilized/current workloads of the information handling system, such as whether the currently executed workloads are network usage heavy workloads, high computation workloads, light workloads, or the like. In certain examples, the high computation workloads may be workloads executed in the information handling system, workloads migrated over the network, or the like.

At block 416, a system level QoS is determined. In an example, the system level QoS may include, but is not limited to, a maximum system power consumption, a maximum computation workload, a thread/application latency, and a schedule policy. At block 418, a determination is made whether the application is a candidate for migration to an offload compute device. In an example, the determination may be made based on different system and application parameters. For example, the determination may be made based on an application performance, a minimum required latency for the application, overall power consumption in the system, or the like.

If the application is not a candidate for migration to an offload compute device, then the flow continues as stated above at block 404 and a new target application is identified. If the application is a candidate for migration, then a combined server response QoS available for computation is determined at block 420. At block 422, a determination is made whether the requested QoS for the identified application can be met by the offload compute device. In an example, the QoS for the identified application may be met if the latency requirement for the application may be met, if the server has available resources to perform the computation workload for the application, or the like. If the requested QoS cannot be met, then the flow continues as stated above at block 404 and a new target application is identified. If the requested QoS can be met, then the workload for the identified target application is moved or migrated to the offload compute device at block 424 and the flow ends at block 412.

FIG. 5 shows a generalized embodiment of an information handling system 500 according to an embodiment of the present disclosure. Information handling system 500 may be substantially similar to information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 562, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 530 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 4394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a quality of service (QOS) table, wherein the QoS table includes a plurality of parameters for a target application;
a processor to communicate with the memory, the processor to:
identify the target application from a plurality of applications;
receive a requested QoS for the target application;
determine a system workload class associated with the target application;
determine a system level QoS associated with the target application;
based on the requested QoS, the system workload class, and the system level QoS, determine a derived QoS for the target application, wherein the requested QoS, the system workload class, the system level QoS, and the derived QoS are stored in the QoS table; and
based on the derived QoS, determine whether the target application is a candidate for migration from the information handling system to an offload compute device.

2. The information handling system of claim 1, wherein in response to the target application being a candidate to migration, the processor further to:
determine whether the offload compute device is able to meet the requested QoS for the target application; and
in response to the offload compute device being able to meet the request QoS, provide the target application to the offload compute device.

3. The information handling system of claim 2, wherein the processor further to: receive data associated with target application from the offload compute device.

4. The information handling system of claim 1, wherein the processor further to: provide the target application to the offload compute device based on the migration to and from the offload compute device being able to meet a latency requirement for the target application.

5. The information handling system of claim 1, wherein the processor further to: assign power/latency quadrant for the target application, wherein the power/latency quadrant identifies a power usage and latency requirement for the target application based on a performance requirement of the target application.

6. The information handling system of claim 1, wherein the requested QoS for the target application includes a processor usage based on an algorithm complexity of the target application.

7. The information handling system of claim 1, wherein in response to the target application not being a candidate for migration, the processor to: assign the target application to a core of the processor for execution.

8. The information handling system of claim 1, wherein the system level QoS includes a maximum system power consumption, a maximum computation workload, a thread/application latency, and a schedule policy.

9. A method comprising:
identifying, by a processor of an information handling system, a target application from a plurality of applications;
receiving a requested quality of service (QOS) for the target application;
determining a system workload class associated with the target application;
determining a system level QoS associated with the target application;
based on the requested QoS, the system workload class, and the system level QoS, determining a derived QoS for the target application;
storing the requested QoS, the system workload class, the system level QoS, and the derived QoS in a QoS table of a memory of the information handling system; and
based on the derived QoS, determining, by the processor, whether the target application is a candidate for migration from the information handling system to an offload compute device.

10. The method of claim 9, wherein in response to the target application being a candidate to migration, the method further comprising:
determining whether the offload compute device is able to meet the requested QoS for the target application; and
in response to the offload compute device being able to meet the request QoS, providing the target application to the offload compute device.

11. The method of claim 10, further comprising: receiving data associated with target application from the offload compute device.

12. The method of claim 10 further comprising: providing the target application to the offload compute device based on the migration to and from the offload compute device being able to meet a latency requirement for the target application.

13. The method of claim 10, further comprising: assigning power/latency quadrant for the target application, wherein the power/latency quadrant identifies a power usage and latency requirement for the target application based on a performance requirement of the target application.

14. The method of claim 9, wherein the requested QoS for the target application includes a processor usage based on an algorithm complexity of the target application.

15. The method of claim 9 wherein in response to the target application not being a candidate for migration, the method further comprises: assigning the target application to a core of the processor for execution.

16. The method of claim 9, wherein the system level QoS includes a maximum system power consumption, a maximum computation workload, a thread/application latency, and a schedule policy.

17. An information handling system comprising:
a memory to store a quality of service (QOS) table, wherein the QoS table includes a plurality of parameters for a target application;
a processor to:
identify the target application from a plurality of applications;
receive a requested QoS for the target application;
determine a system workload class associated with the target application;
determine a system level QoS associated with the target application;
based on the requested QoS, the system workload class, and the system level QoS, determine a derived QoS for the target application, wherein the requested QoS, the system workload class, the system level QoS, and the derived QoS are stored in the QoS table;
based on the derived QoS, determine whether the target application is a candidate for migration from the information handling system to an offload compute device;
in response to the target application being a candidate to migration:
determine whether the offload compute device is able to meet the requested QoS for the target application; and
in response to the offload compute device being able to meet the request QoS, provide the target application to the offload compute device; and
in response to the target application not being a candidate for migration, assign the target application to a core of the processor for execution.

18. The information handling system of claim 17 wherein the processor provides the target application to the offload compute device based on the migration to and from the offload compute device being able to meet a latency requirement for the target application.

19. The information handling system of claim 17, wherein the processor assigns power/latency quadrant for the target application, wherein the power/latency quadrant identifies a power usage and latency requirement for the target application based on a performance requirement of the target application.

20. The information handling system of claim 17, wherein the system level QoS includes a maximum system power consumption, a maximum computation workload, a thread/application latency, and a schedule policy.
